(19) United States
(12) Patent Application Publication
(10) Pub. No.: US 2011/0167884 A1
(43) Pub. Date: Jul. 14, 2011

(54) DEVICE FOR LOCKING A BATHROOM DOOR

(75) Inventors: Robert Dumortier, Le Mans (FR); Anne-Laure Dumortier, Le Mans (FR)

(73) Assignee: Societe Nationale Des Chemins De Fer Francais SNCF, Paris (FR)

(21) Appl. No.: 13/063,673

(22) PCT Filed: Sep. 18, 2009
(86) PCT No.: PCT/FR2009/051757

§ 371 Date: Mar. 11, 2011

(30) Foreign Application Priority Data
Sep. 18, 2008 (FR) 0856264

(51) Int. Cl. E05B 41/00; E05B 65/00

(52) U.S. Cl. 70/91

(57) ABSTRACT

Device for locking the door of a toilet cubicle comprising a door locking element operated manually from inside the cubicle, the said locking element allowing the vacant and engaged states of the cubicle to be selected and the door to be locked when the engaged state is selected, the said device including an information mechanism located on the door at least on the outside of the cubicle and providing at least two tactile and visual indicators of the state selected by the locking element, characterized in that the information mechanism includes raised pictograms to provide a tactile indicator.

### CROSS REFERENCE TO RELATED APPLICATIONS

This application is a National Stage application under 35 U.S.C. §371 of PCT Application No. PCT/FR2009/051757, filed Sep. 18, 2009, which claims priority to French Application No. FR 0856264, filed Sep. 18, 2008, entitled “Device for Locking a Bathroom Door.”

### FIELD OF THE INVENTION

The invention relates to the field of devices for locking a door from inside a room that is to be locked. This invention concerns more particularly devices for locking the door of a toilet cubicle that may be installed, on the one hand, in railway vehicles but also in aircraft, road vehicles or ships, and on the other hand, in public places such as stations, museums, restaurants, hotels or public highways.

### BACKGROUND OF THE PRIOR ART

Generally speaking, door-locking devices can provide persons outside the cubicle with visual information about whether the cubicle is vacant or engaged. Usually, illuminated signs or colour codes are used, such as green to indicate that the cubicle is vacant and red to indicate that the cubicle is engaged.

However, such locking devices do not enable the partially-sighted to be informed as to whether the cubicle is engaged or vacant. They are therefore obliged to seek assistance from a third party.

The object of the invention is therefore to provide a solution to facilitate the journey or daily activities of the partially-sighted in a vehicle or in public places and to improve their comfort during their journey or travel. The object is also to make it simpler for all users to use the cubicle and determine whether it is vacant or engaged.

### SUMMARY OF THE INVENTION

The invention thus relates to a device for locking the door of a toilet cubicle comprising a door-locking element operated manually from inside the cubicle. Said locking element allows the vacant and engaged states of the cubicle to be selected and the door to be locked when the engaged state is selected.

Moreover, such a device includes an information mechanism located on the door at least on the outside of the cubicle and providing two tactile and visual indicators of the state selected by the locking element.

According to the invention, this device is characterised in that the information mechanism includes raised pictograms to provide a tactile indicator.

In other words, when a partially-sighted person wishes to know whether the cubicle is vacant or engaged, he/she must touch the information mechanism on the door and identify the corresponding tactile and visual indicator by means of the pictograms located on the information mechanism. When a person enters the toilet cubicle and wishes to lock its door, he/she moves the locking element to select the engaged state. Working the locking element also operates the information mechanism so as to make the portion corresponding to the engaged state of the cubicle accessible to touch and visible.

Advantageously, the information mechanism provides a third tactile and visual indicator corresponding to the cubicle being out of order.

Thus, according to a first embodiment, the third tactile and visual indicator can be selected by an authorised person using a key from outside the cubicle.

In other words, the authorised person, who may be a ticket inspector in a vehicle, can lock the toilet cubicle from the outside using a special key. The information mechanism is therefore, in this case, also moved so as to provide a third tactile and visual indicator distinct from the two preceding ones. This third tactile and visual indicator can only be selected by an authorised person. It cannot be selected from inside the cubicle by means of the locking element.

According to a second embodiment, the third tactile and visual indicator can be selected automatically.

In this case, the third tactile and visual indicator is selected automatically by the automated device of the toilet cubicle when a fault is detected such as a full or blocked bowl for example.

Furthermore, the connection between the locking element and the information mechanism can be of various types.

Thus, according to a first embodiment, the locking device can include a mechanical connection located between the locking element and the information mechanism. Such a mechanical connection can include elements such as gears, cams, connecting rods, etc.

According to a second embodiment, the locking device can comprise an electrical connection located between the locking element and the information mechanism. A servomotor can thus control the movement of the information mechanism.

According to a particular embodiment, the information mechanism can be a one-piece assembly that is movable in rotation and includes three differently shaped areas, each distributed around a 120-degree angular sector.

In this way, the rotation of the information mechanism, controlled by the locking element or key from outside the cubicle, displays one of the three specially-shaped areas in an opening made in the door. Each of the three areas is therefore alternately accessible to touch and visible when the information mechanism is rotated through 120 degrees. Each distinctive shape corresponds to a specific state of the toilet cubicle.

According to another embodiment, the information mechanism may be an assembly formed by at least two elements, one of the two elements being capable of covering the other element. In this case, the Out of Order information element can therefore be distinct from that of the vacant and engaged states and formed by a disc or cap capable of covering the other two elements when it is actuated.

Advantageously, the information mechanism can comprise raised pictograms providing a tactile indicator. Raised pictograms can be easily identified by a partially-sighted person.

Advantageously, the information mechanism can be arranged in the immediate vicinity of the handle used to open the cubicle door. This arrangement is particularly advantageous when the connection between the information mechanism and the locking element is of a mechanical type. This position also makes it easy to glean the information due to its intuitive nature.

According to a first embodiment, the locking element can be movable in translation between two positions corresponding to the vacant and engaged states of the cubicle. Consequently, the user merely has to push or pull the locking element after having closed the cubicle door.

According to a second embodiment, the locking element can be movable in rotation between two positions corresponding to the vacant and engaged states of the cubicle. In this case, the user merely has to rotate the locking element once the cubicle door has been closed.

In practice, the information mechanism can be positioned on the door inside the cubicle. In this way, once the locking element has been actuated, it is possible for a partially-sighted person to check whether the door is properly locked.

### BRIEF DESCRIPTION OF THE DRAWINGS

The method of embodying the invention as well as the advantages deriving therefrom will emerge from the following description of a non-limiting embodiment which is shown by way of example in the accompanying drawings, in which:

FIGS. 1 and 2 represent internal views of a toilet cubicle door fitted with a locking device according to the invention,

FIGS. 3, 4 and 5 represent external views of the toilet cubicle door,

FIGS. 6 and 7 represent a front view of two variations of an information mechanism according to the invention.

### DESCRIPTION OF THE PREFERRED EMBODIMENTS

As previously stated, the invention relates to a device for locking the door of a toilet cubicle.

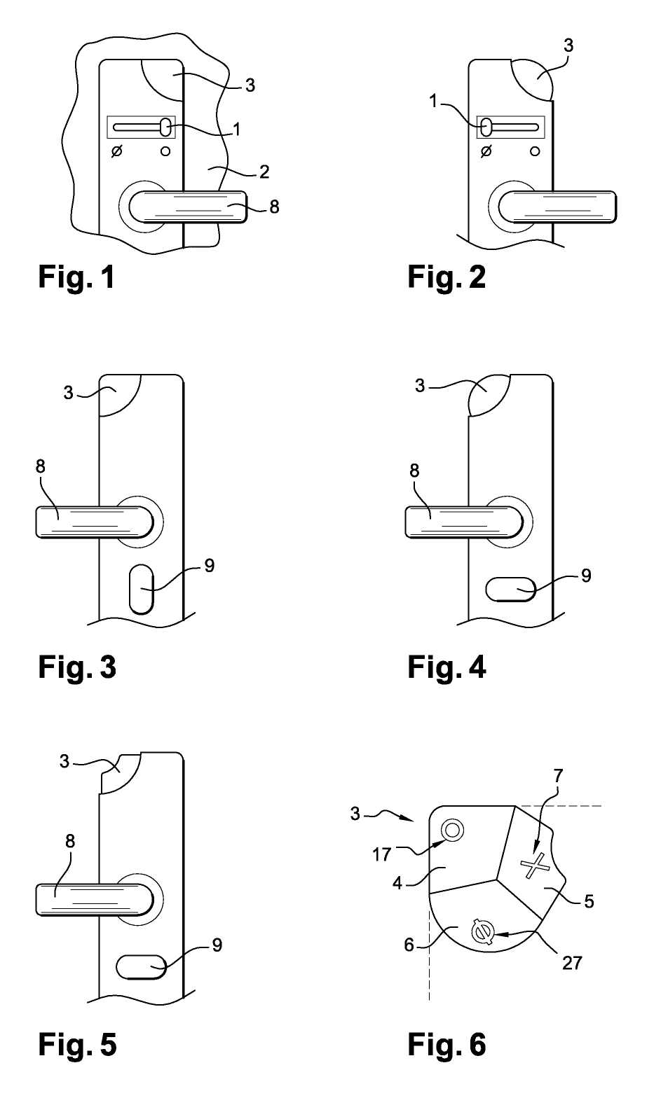

As shown in FIG. 1, such a locking device comprises a locking element (1) located inside the cubicle and enabling the door (2) to be locked or opened by means of a handle (8). Furthermore, the locking device includes an information mechanism (3) which can be positioned on the inside of the door to provide information for the occupant.

As shown in FIG. 2, when a person wishes to lock the cubicle door, he/she moves the locking element (1) to select the cubicle-engaged state and lock the door. At the same time, the information mechanism (3) changes shape in order to enable a partially-sighted user to check the selected state of the cubicle.

As shown in FIG. 3, the locking device also has an information mechanism (3) located on the outside of the cubicle. The state selected is the vacant state of the cubicle. Moreover, a lock (9) can enable an authorised person to lock the door (2) from the outside.

As shown in FIG. 4, the information mechanism enables an engaged state of the cubicle to be displayed on the outside.

As shown in FIG. 5, the information mechanism (3) enables an out of order state of the cubicle to be displayed. This state can be selected by an authorised person by means of a special key introduced into the lock (9) or else automatically.

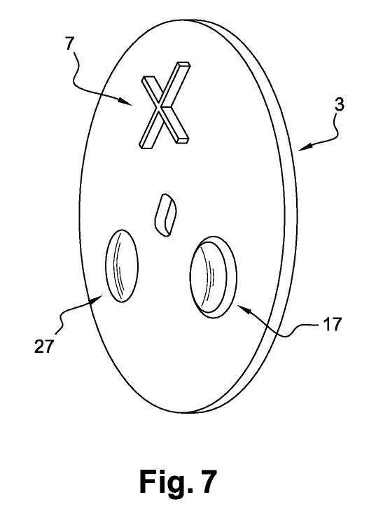

As shown in FIG. 6, the information mechanism (3) has three areas (4, 5, 6) of different shapes, each area being distributed around a 120-degree angular sector. Furthermore, pictograms (7, 17, 27) are positioned on the information mechanism so as to make it easier to determine which cubicle state has been selected.

The “vacant” state can be symbolised by a pictogram (17) formed by a circle raised in relation to a background of the information mechanism (3) whereas the “engaged” state can be symbolised by a pictogram (27) formed by a raised crossed circle.

The “out of order” state of the toilet cubicle can be symbolised by a pictogram (7) formed, for example, by a raised cross higher than 1 mm.

As shown in FIG. 7, the information mechanism (3) can also include pictograms (7, 17, 27) in other forms. Thus, the “vacant” state of the cubicle can be symbolised by a pictogram (17) formed by a spherical portion which is recessed and raised in relation to the background of the information mechanism (3).

As for the “engaged” state of the cubicle, it can be symbolised by a pictogram (27) formed by a domed spherical raised portion.

These domed or recessed spherical portions can each have a diameter of approximately 10 mm and have a raised height of more than 1.5 mm.

The above shows that a locking device according to the invention has several advantages, namely:

it informs the partially-sighted of the state of engagement of a toilet cubicle.
it is extremely simple to use,
it is relatively simple to install and does not involve very high costs.

1. Device for locking the door of a toilet cubicle comprising a door locking element operated manually from inside the cubicle, the said locking element (1) allowing the vacant and engaged states of the cubicle to be selected and the door to be locked when the engaged state is selected, the said device including an information mechanism located on the door at least on the outside of the cubicle and providing at least two tactile and visual indicators of the state selected by the locking element, characterized in that the information mechanism includes raised pictograms to provide a tactile indicator.

2. Locking device according to claim 1, characterised in that the information mechanism provides a third tactile and visual indicator corresponding to the cubicle being out of order.

3. Locking device according to claim 2, characterised in that the third tactile and visual indicator is selected by an authorised person using a key from outside the cubicle.

4. Locking device according to claim 2, characterised in that the third tactile and visual indicator is selected automatically.

5. Locking device according to claim 1, characterised in that it includes a mechanical connection located between the locking element and the information mechanism.

6. Locking device according to claim 1, characterised in that it includes an electrical connection located between the locking element and the information mechanism.

7. Locking device according to claim 2, characterised in that the information mechanism is a one-piece assembly that is movable in rotation and includes three differently shaped areas, each distributed around a 120-degree angular sector.

8. Locking device according to claim 1, characterised in that the information mechanism is an assembly formed by at least two elements, one of the said at least two elements being capable of covering the other element.

9. Locking device according to claim 1, characterised in that the information mechanism is arranged in the vicinity of the handle used to open the cubicle door.

10. Locking device according to claim 1, characterised in that the locking element is movable in translation between two positions corresponding to the vacant and engaged states of the cubicle.

11. Locking device according to claim 1, characterised in that the locking element is movable in rotation between two positions corresponding to the vacant and engaged states of the cubicle.

12. Locking device according to claim 1, characterised in that information mechanism is positioned on the door inside the cubicle.
